(19) United States
(12) Patent Application Publication
(10) Pub. No.: US 2008/0292837 A1
(43) Pub. Date: Nov. 27, 2008

(54) Apparatus and Method for Injection Molding a Fully-Assembled Multi-Component Articulatable Device

(76) Inventor: Glenn H. Mackal, South Pasadena, CA (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/124,342

(22) Filed: May 21, 2008

Related U.S. Application Data
(60) Provisional application No. 60/939,347, filed on May 21, 2007.

(51) Int. Cl. B32B 7/04; B29C 45/00

(52) U.S. Cl. 428/101; 264/242

(57) ABSTRACT

An apparatus and method for simultaneously injection molding a first component and a second component, the second component having a protrusion that is positioned in a hole in the first component, including the steps of mating together molds having cavities that define the first component and the second component, positioning a gated core pin in one of the molds, the gated core pin having an outer configuration to define the hole in the first component and having a blind hole to define the protrusion in the second component, injecting a material into the cavities to form the first component and the second component and withdrawing the gated core pin from the mold, whereupon the protrusion on the second component is positioned in the hole in the first component allowing movement of the first component relative to the second component.

### CROSS-REFERENCE TO RELATED APPLICATIONS

This application claims the benefit of provisional patent application 60/939,347, filed May 21, 2007, the disclosure of which is hereby incorporated by reference herein.

### BACKGROUND OF THE INVENTION

1. Field of the Invention

This invention relates to an apparatus and method for injection molding a multi-component, fully-assembled articulated device. More particularly, this invention relates to an apparatus and method for injection molding a multi-component articulatable device that is fully-assembled upon ejection from the mold thereby obviating the need for separately injection molding each component for subsequent assembly.

2. Description of the Background Art

Presently, there exist many techniques for injection molding. One method for molding a multi-component device includes a first step of injection molding a first component in a first component mold and then manually transferring the first component into another mold whereupon a second component is then injection-molded to couple or otherwise encompass the first component to achieve a molded assembly comprising multiple components. Unfortunately, however, the step for transferring the first component from the first component mold to the second component mold significantly increases the cost of manufacture of the multi-component device.

More contemporary injection molding techniques for molding multiple components eliminate the need for manually transferring the first component from the first component mold into the mold of the second component. Rather, the process occurs in what is commonly referred to as a two-shot injection molding process that does not require any manual transferring of the molded in-situ first component. Unfortunately, however, in-situ two-shot injection molding of multiple-component devices generally preclude any articulation from occurring between the components since they are molded in-situ together.

Consequently, the predominate method for manufacturing a multi-component articulated device usually comprises injection-molding the individual components thereof separately whereupon they are then subsequently assembled together by hand or by an assembly machine. The need to subsequently assemble the separately-injection molded components of the device significantly increases the cost of manufacturing the device.

Hence, there presently exists a need for an apparatus and method for injection molding of a multi-component articulated device in which the individual components thereof are injection molded in a fully-assembled state.

Therefore, it is an object of this invention to provide an improvement which overcomes the aforementioned inadequacies of the prior art devices and provides an improvement which is a significant contribution to the advancement of the injection-molding manufacturing art.

Another object of this invention is to provide an injection-molding apparatus and method for injection molding a fully-assembled articulated device in a single mold such that once the device is ejected from the mold, the device is fully-assembled and the components thereof are articulated with respect to each other.

Another object of this invention is to provide an injection molding apparatus and method for injection-molding a fully-assembled articulated device comprising two or more components that are articulatable in a rotational or linear manner with respect to each other.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an injection-molding apparatus and method in which a fully-assembled, articulated multi-component device is injection-molded in a single injection mold in one injection step such that upon ejection from the mold, the multi-components of the device are fully assembled, yet articulatable with respect to each other.

More particularly, to achieve rotational articulation, the apparatus and method of the invention employs opposing gated core pins that extend through opposing sides of the mold cavity forming one component to form axial holes through the sides of the first component cavity. Each of the gated core pins includes an axial hole whose opening is contiguous with the second component mold cavity. Increased-diameter axial holes are created in the opposing sides of the first component and reduced-diameter axles are thus created on opposing sides of the second component. During injection, the reduced-diameter axles formed on the second component are therefore positioned in the increased-diameter axial holes.

In one embodiment, the gated core pins may each comprise a substantially circular cylindrical outer configuration to achieve a substantially circular cylindrical axial hole in the opposing sides of the first component and its blind hole may comprise a substantially circular cylindrical configuration to achieve a substantially circular cylindrical axle formed on the opposing sides of the second component such that after injection, the first and second components are allowed to rotate relative to each other.

In another embodiment, the gated core pins may each comprise a wide generally-wide flat configuration having a blind hole formed therein such that a generally-wide slot is formed in the opposing sides of the first component. After an injection molding and ejection from the mold, the axles formed on the opposing sides of the second component may easily slide within the length of the slots thereby achieving linear articulation. The axles may comprise a generally circular cylindrical configuration to achieve rotation as well as linear articulation.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of an exemplar device manufactured according to the apparatus and method of the present invention in which multiple components with rotational articulation are injection-molded fully assembled within a mold;

FIG. 2 is a cross-sectional view of FIG. 1 along lines 2-2 showing the cross-sectional configuration of the rotationally articulated multiple components of the device of FIG. 1;

FIG. 3 is a top plan view of the bottom cavity of the injection mold used in the manufacture of the device of FIG. 1 showing the opposing gated core pins in alignment therewith;

FIG. 4 is a cross-sectional view of the two halves of the mold along lines 4-4 of FIG. 3 showing the mold cavities of the first component and the second component;

FIG. 5 is a cross-sectional view of the two halves of the mold and the core pins along lines 5-5 of FIG. 3 showing the cavities for the first component and the axle to be formed on the second component;

FIG. 6 is a cross-sectional view of the two halves of the mold along lines 6-6 of FIG. 3 showing the fully-inward gating of the core pins to form the axial holes in the opposing sides of the first component and the respective axles on opposing sides of the second component;

FIG. 7 is a perspective view of an exemplar device manufactured according to the apparatus and method of the present invention in which multiple components with linear articulation are injection-molded fully assembled within a mold;

FIG. 8 is a cross-sectional view of FIG. 7 along lines 8-8 showing the cross-sectional configuration of the linear articulated multiple components of the device of FIG. 7;

FIG. 9 is a perspective view of the injection mold used in the manufacture of the device of FIG. 7 showing the wide, flat gated core pins in cross-section with center blind hole in alignment therewith; and

FIG. 10 is a perspective view of the injection mold used in the manufacture of the device of FIG. 7 showing the fully-engaged wide, flat gated core pins in cross-section with center blind hole in alignment therewith.

Similar reference characters refer to similar parts throughout the several views of the drawings.

### DETAILED DESCRIPTION OF THE PREFERRED EMBODIMENT

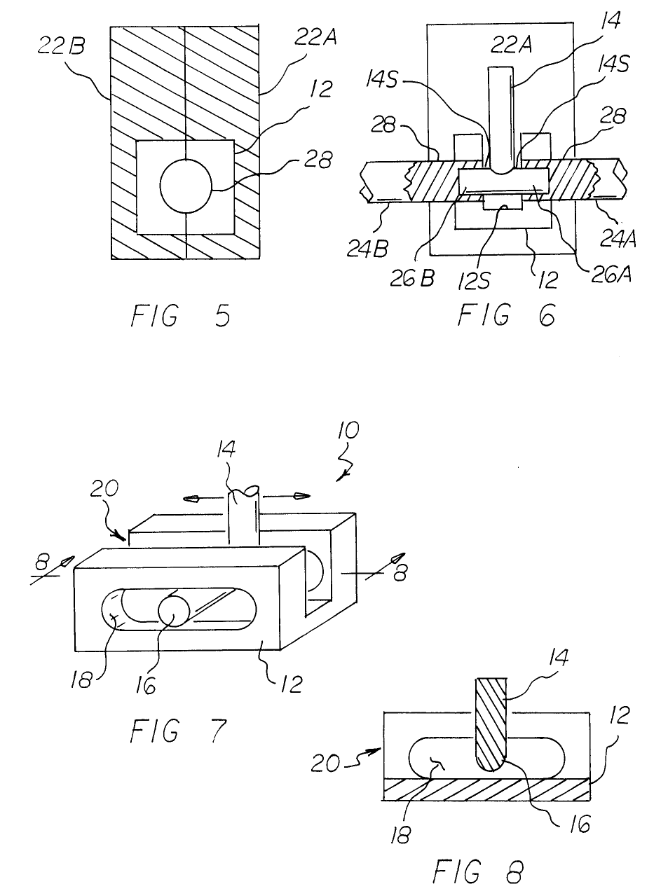

FIGS. 1-6 illustrate one embodiment of the apparatus and method 10 of the invention which achieves the injection molding of a fully-assembled multi-component device having rotational articulation.

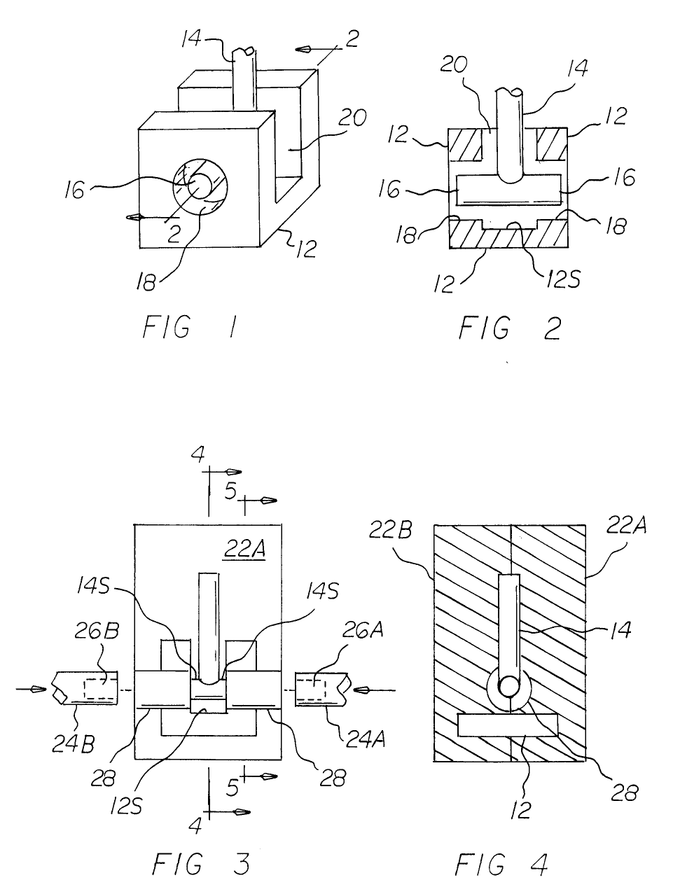

More particularly, referring to FIGS. 1 and 2, the apparatus and method 10 of the invention includes a first component 12 and a second component 14 rotatably articulated together by a pair of axles 16 extending from opposing sides of the second component 14 which are rotatably journalled within corresponding axial holes 18 that allow rotational articulation of the second component 14 relative to the first component 12.

The first component 12 may comprise any desired configuration adapted to receive the second component 14 such as the exemplar block-shaped configuration having a transverse mid-slot 20 that allows annular movement of the second component 14 (e.g., 180 degrees) relative to the first component 12.

According to the apparatus and method of the invention, the first and second components 12 and 14 are molded in a mold in their assembled configuration shown in FIGS. 1 and 2. More specifically, fully-assembled injection molding of the first and second components 12 and 14 is achieved according to the present invention using mating halves of an injection mold 22A and 22B having cavities which form mirrored halves of the components 12 and 14 and that additionally include gated core pins 24A and 24B that serve to form the axial holes 18 in the opposing sides of the first component 12 and corresponding axles 16 on the second component 14.

The gated core pins 24 each include an axial blind hole 18 formed in the end thereof. The outer configuration of the gated core pins 24A and 24B define the configuration of the axial holes 18 in the opposing sides of the first component 12 whereas the inner configuration and depth of the axial blind holes 26A and 26B determine the outer configuration and length of the axles 16 extending from the opposing sides of the second component 14. As shown, the gated core pins 24 and their respective blind holes 26 may each comprise a generally circular cylindrical configuration such that the axial holes 18 comprise a generally cylindrical configuration and the corresponding axles 18 each comprise a generally circular cylindrical configuration with the inner diameter of the axial holes 18 comprising a increased diameter and the outer diameter of the axles 16 comprising a reduced diameter.

It is noted that in most devices, a loose-tolerance fit between the axial holes 18 and the respective axles 16 will not adversely affect functionality; however, an increased tighter fit of the axles 16 within the holes 18 may be achieved by dimensioning the outer diameter of the core pin 24 to be only appreciably greater than the inner diameter of its blind hole 26. It is also noted that the depth of the blind hole 26 within each of the pins 24 determines the length of the axle 16 extending into, or through, the opposing sides of the first component 12. Consequently, the depth of the blind holes 26 may be dimensioned such that the axles 16 remain recessed within the opposing sides of the first component 12 or the depth may be increased such that the axles 16 protrude from the opposing sides of the first component 12.

As best shown in FIGS. 3 and 6, the cavity for the second component 14 may be configured to include stub-axle cavities 14S so as to generally increase the amount of spacing available between the first and second components 12 and 14. Likewise, the cavity for the first component 12 may include a stub slot 12S positioned at the bottom of the intended placement of the mid slot 12 so as to increase the amount of spacing of the cavities between the first and second components 12 and 14.

During manufacturing, the two mold halves 22A and 22B are mated together and the gated core pins 24A and 24B are moved inwardly into access holes 28A and 28B formed on opposing sides of the mold halves 22A and 22B in alignment with the holes 18 and axles 16 to be formed in the first and second components 12 and 14, respectively. Liquid plastic or other resin is then injected into the mold cavities via injection ports (not shown). The mold halves 22A and 22B are cooled (e.g., by a cooling liquid through manifolds, not shown). After cooling, the core pins 24A and 24B are withdrawn and the mold halves 22A and 22B are separated whereupon the injection molded fully-assembled rotationally articulated components 12 and 14 are ejected from the mold (e.g., by an ejector). It is noted that the provision for the spacing 125 and 14S on the first and second components 14 and 14, respectively, along with the use of the blind holes 26A and 26B in the gated core pins 24A and 24B results in the second component 14 being rotatably articulated and assembled with the first component 12 upon injection molding.

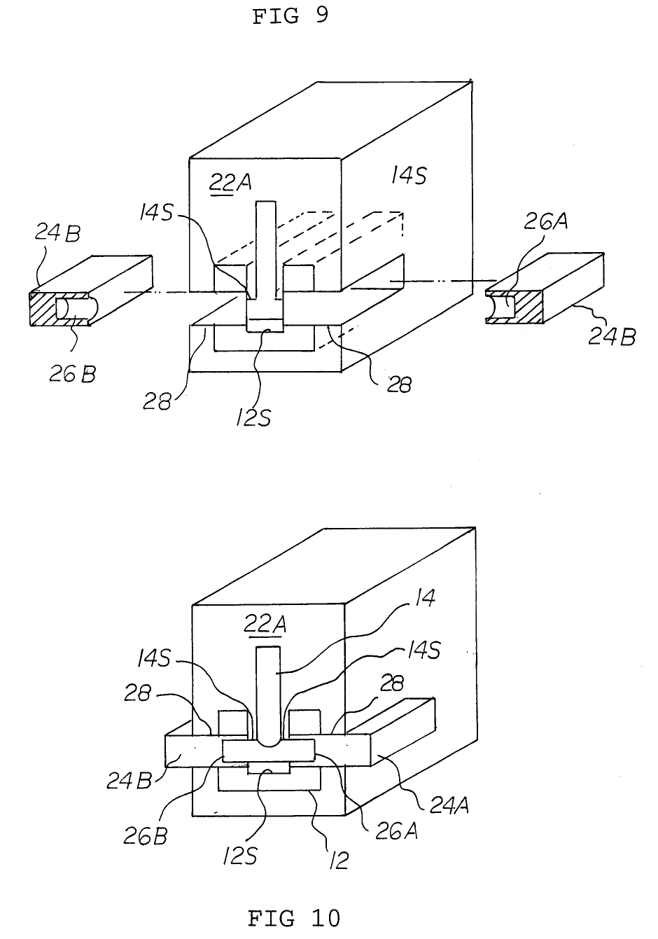

Referring now to FIGS. 7-10, a second embodiment of the apparatus and method 10 of the invention utilizes gated core pins 24A and 24B that are elongated in a width-wise direction to form the respective axial holes 18 in the opposing sides of the first component 12 in the form of elongated slots rather than circular cylindrical holes as described in conjunction of the first embodiment of FIGS. 1-6. As best shown in FIG. 7, the axial hole 18 of the second embodiment comprising a slot allows the axles 16 of the second component 14 to move linearly along the length of the slot to achieve linear articulation of the second component 14 relative to the first component 12. Further, as shown in FIGS. 7-10, axial blind holes 18 in the wide core pins 24 may comprise a generally circular cylindrical configuration to form during injection circular cylindrical axles 16 on opposing sides of the second component 14 such that the second component 14 may rotationally as well as linearly, travel along the length of the slot-shaped axial hole 18 formed in the opposing sides of the first component 12.

The first and second embodiments described above are intended to be exemplary of the relative rotational and linear articulation that may be achieved between the first and second components 12 and 14 when they are injection-molded fully assembled in a mold. Therefore, without departing from the spirit and scope of this invention, it shall be understood that the configurations of the first and second components 12 and 14 may be adapted to any particular use in which rotational and/or linear articulation is desired in a fully-assembled multi-component injection molded device.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for simultaneously injection molding a: first component and a second component, the second component having a protrusion that is positioned in a hole in the first component, comprising the steps of:
mating together molds having cavities that define the first component and the second component;
positioning a gated core pin in one of the molds, the gated core pin having an outer configuration to define the hole in the first component and having a blind hole to define the protrusion in the second component;
injecting a material into the cavities to form the first component and the second component; and
withdrawing the gated core pin from the mold, whereupon the protrusion on the second component is positioned in the hole in the first component allowing movement of the first component relative to the second component.

2. The method as set forth in claim 1, further including two of the gated core pins positioned on opposing sides of the first component and the second component that are withdrawn after injection of the material into the cavities to form the first component and the second component, whereon the protrusions formed on the opposing sides of the second component are movable in the respective holes formed in the opposing sides of the first component allowing movement of the first component relative to the second component.

3. The method as set forth in claim 2, wherein each of the blind holes of the gated core pins comprises a generally circular cylindrical configuration such that the holes formed in the opposing sides of the first component each comprise a generally circular cylindrical configuration.

4. The method as set forth in claim 3, wherein each of the outer configurations of the gated core pins comprises a generally wide flat configuration such that the holes formed in the opposing sides of the first component each comprise a slot.

5. The method as set forth in claim 3, wherein each of the outer configurations of the gated core pins comprises a generally circular cylindrical configuration such that the holes formed in the opposing sides of the first component each comprise a generally circular cylindrical axial hole.

6. The method as set forth in claim 5, wherein the cavity defining the second component comprises a stub-axle cavity to generally increase the amount of spacing between the first component and second components.

7. The method as set forth in claim 5, wherein the cavity defining the first component comprises a stub slot cavity to generally increase the amount of spacing between the first and second components.

8. The method as set forth in claim 1, wherein the plurality of molds comprises two mold halves that are mated together.

9. An articulatable apparatus, comprising in combination:
a first component with a hole;
a second component with a protrusion articulatably movable within the hole of the first component;
the first component and the second component being simultaneously formed together in an injection mold with the protrusion positioned within the hole.

10. The articulatable apparatus as set forth in claim 9, wherein the protrusion is formed within the hole when the first component and the second component are simultaneously injection molded together by a gated core pin positioned in the mold, the gated core pin having an outer configuration to define the hole in the first component and having a blind hole to define the protrusion in the second component.

11. The articulatable device as set forth in claim 10, further including two of the gated core pins positioned on opposing sides of the first component and the second component to form the protrusions on the opposing sides of the second component that are movable in the respective holes formed in the opposing sides of the first component allowing movement of the first component relative to the second component.

12. The articulatable device as set forth in claim 11, wherein each of the blind holes of the gated core pins comprises a generally circular cylindrical configuration such that the holes formed in the opposing sides of the first component each comprise a generally circular cylindrical configuration.

13. The articulatable device as set forth in claim 12, wherein each of the outer configurations of the gated core pins comprises a generally wide flat configuration such that the holes formed in the opposing sides of the first component each comprise a slot.

14. The articulatable device as set forth in claim 12, wherein each of the outer configurations of the gated core pins comprises a generally circular cylindrical configuration such that the holes formed in the opposing sides of the first component each comprise a generally circular cylindrical axial hole.
